(19) United States
(12) Patent Application Publication
(10) Pub. No.: US 2006/0128334 A1
(43) Pub. Date: Jun. 15, 2006

(54) Wireless communication receiver

(76) Inventors: Isao Ikuta, Yokohama (JP); Akio Yamamoto, Hiratsuka (JP); Yutaka Igarashi, Yokohama (JP); Stephen Goodwin, Cambridge (GB)

Correspondence Address: MCDERMOTT WILL & EMERY LLP, 600 13TH STREET, N.W., WASHINGTON, DC, 20005-3096, US

(21) Appl. No.: 11/170,086

(22) Filed: Jun. 30, 2005

(30) Foreign Application Priority Data
Jun. 30, 2004 (GB) 0414682.5

(51) Int. Cl. H04B 1/06; H04B 7/00

(52) U.S. Cl. 455/232.1

(57) ABSTRACT

To reduce circuit area and power consumption and suppress transient response occurring at switching in PGA of a programmable gain amplifier is provided a wireless communication receiver comprising PGAs for adjusting the gain of a received signal down-converted by mixers and sending it to base-band block. Within PGAs are provided HPFATT circuits formed of capacitors arranged in series, and ladder resistors arranged in parallel, with signal lines, and a plurality of switches. HPFATT is a circuit serving as a high-pass filter and an attenuator for gain switching, wherein switches are controlled by control signal sg from a controller. Amplifiers connected to the rear stage of the HPFATT circuit are formed of MOS transistors.

### CROSS-REFERENCE TO RELATED APPLICATION

The present application claims priority from UK patent application No. GB 0414682.5 filed on Jun. 30, 2004, the content of which is hereby Incorporated by reference into this application.

### BACKGROUND OF THE INVENTION

The present invention relates to a wireless communication receiver and, more particularly, it relates to a wireless communication receiver capable of setting up a gain attenuation by switching over a plurality of switches in a programmable gain amplifier.

In a conventional wireless communication receiver in which signal lines are AC-coupled, a transient response occurs when the gain of programmable gain amplifier composed of a multiple stages of amplifiers is switched. As measures to cope with the transient response, there is known such a method as to perform the switching of gain at timing except when a control signal or a signal susceptible to noises is received (refer to, for example, Japanese Patent Laid-open No. 2003-110440) or such a method as to vary the time constant of a filter when the level of the transient response has exceeded a tolerable limit, thereby shortening the time of the transient response coming to cease (refer to, for example, Japanese Patent Laid-open No. 2003-224488).

### SUMMARY OF THE INVENTION

However, in the method as a solution of the problem of transient response to switch the gain at timing except when a control signal or a signal susceptible to noises Is received, the control signal can be received well but a part of the signal becomes unreceivable from other packet data.

Further, in the method to vary, when the level of transient response has exceeded a tolerable limit, the time constant of a filter to thereby shorten the time of the transient response coming to cease, it is required to add gain variation detecting circuitry and filter controlling circuitry. Hence, the circuit area becomes larger and current consumption increases.

Such a method may also be considered in which gain is not varied by switching but it is linearly switched by controlling a bias current in the amplifier so that the occurrence of the transient response itself is lessened. However, It requires a voltage-current converting circuit for converting an external control voltage signal into a control current and, therefore, such a difficulty arises that the circuit area becomes large and current consumption increases.

Accordingly, an object of the present Invention is to provide a wireless communication receiver capable of suppressing transient response, i.e., switching transient, occurring when gain in a programmable gain amplifier is converted and capable of reducing the circuit area and current consumption.

An exemplary representative apparatus of the present invention will be shown as follows. That is, the present invention Is a wireless communication receiver comprising a programmable gain amplifier (PGA 10 and 11 as shown in FIG. 1) and a gain controller (CNTL 12 as shown in PIG. 1) for controlling gain in the programmable gain amplifier. The programmable gain amplifier includes an attenuator (HPFATT 30, 32, and 35 as shown in FIG. 1) made up of a plurality of voltage dividing resistors connected in series between signal input nodes and a reference potential point and a plurality of switches connected between a plurality of nodes of the voltage dividing resistors and signal output nodes. The attenuator is set up to a specified attenuation by the gain controller bringing selected switches of the plurality of switches in the programmable gain amplifier into conduction and, by the set up attenuation, the gain in the programmable gain amplifier is established. In the described way, functions characteristic of the present invention are performed.

According to the present invention, suppression of the level of transient response occurring at the time when gain is switched over in the programmable gain amplifier in the wireless communication receiver can be attained by a small circuit area and, in addition, with small current consumption.

### BRIEF DESCRIPTION OF THE DRAWINGS

FIG. 1 is a circuit block diagram showing a structure of a first embodiment of a wireless communication receiver according to the present invention.

FIG. 2 is a circuit diagram showing a configuration example of an amplifier within PGA of FIG. 1.

FIG. 3 is a circuit diagram showing a configuration example of a low-pass filter within PGA of FIG. 1.

FIG. 4 is a circuit diagram showing a configuration example of HPFATT within PGA of FIG. 1.

FIG. 5 is a sectional structural view showing an example in which parasitic components are generated in MOS switch portions and an offset is generated therebetween.

FIG. 6A is a diagram showing timing charts of a control signal and a waveform of transient response.

FIG. 6B is a diagram showing timing charts of a control signal and a waveform of transient response.

FIG. 6C is a diagram showing timing charts of a control signal and a waveform of transient response.

FIG. 7A is a diagram showing timing charts of a control signal for suppressing transient response and a waveform of transient response.

FIG. 7B is a diagram showing timing charts of a control signal for suppressing transient response and a waveform of transient response.

FIG. 7C is a diagram showing timing charts of a control signal for suppressing transient response and a waveform of transient response.

FIG. 8 is a block diagram showing a configuration example of PGA In a second embodiment.

FIG. 9 is a circuit diagram showing a configuration example of a slow switch of FIG. 8.

FIG. 10A is a diagram showing a control signal input to the slow switch and a control signal output from the same.

FIG. 10B Is a diagram showing a control signal input to the slow switch and a control signal output from the same.

### DESCRIPTION OF THE PREFERRED EMBODIMENTS

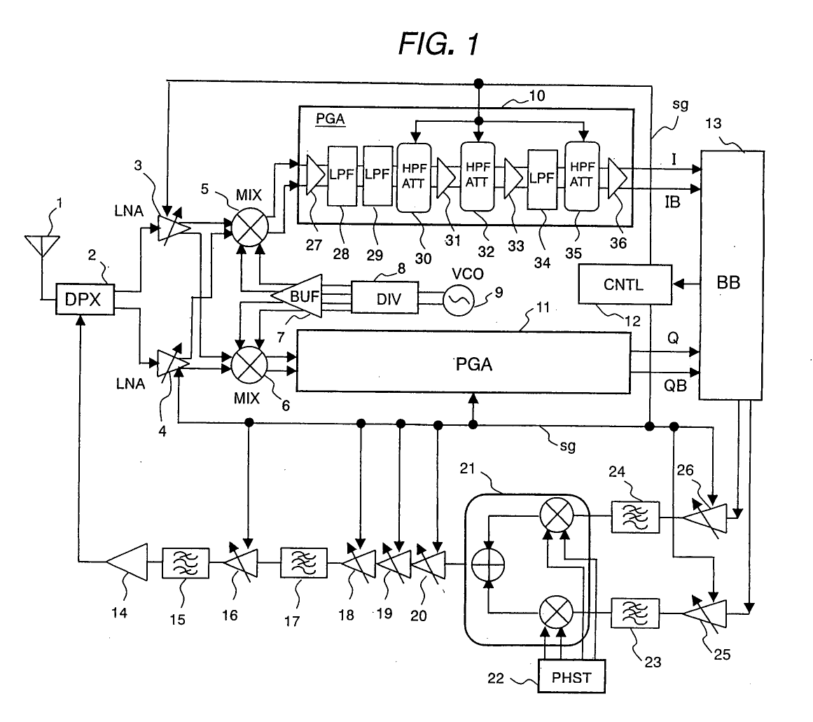

FIG. 1 is a circuit block diagram of a direct-conversion transmitter/receiver showing a first embodiment of the present invention. In FIG. 1, components shared between transmitting and receiving functions are antenna 1 for transmitting and receiving signal, duplexer (DPX) 2 suppressing leakage of a received signal into the transmitting system and suppressing leakage of a transmitted signal into the receiving system, base-band block (BB) 13 for performing analog-digital conversion and digital-analog conversion of a received signal for outputting the signal, and controller (CNTL) 12 receiving signals from base-band block 13 for outputting control signal sg to each circuit.

The receiving system is made up of low noise amplifiers (LNA) 3 and 4 formed of a differential amplifier for amplifying a high-frequency signal received through antenna 1, mixers (MIX) 5 and 6 for frequency converting a received signal, voltage-controlled oscillator (VCO) 9 for generating a local signal, voltage divider (DIV) 8 for dividing the local signal, buffer (BUF) 7 for keeping the output level of the local signal, and programmable gain amplifiers (PGA) 10 and 11 for adjusting gain of the received signal, frequency-converted by multiplication of the received signal with the local signal in MIXs 5 and 6, and eliminating interference waves therefrom. Since PGA 10 and PGA 11 are of the same configuration, the internal block diagram of PGA 11 is omitted in FIG. 1.

The transmitting system is made up of variable amplifiers 16, 18, 19, 20, 25, and 26 for adjusting gain in a transmitted signal from base-band block 13, low-pass filters 17, 23, and 24 for eliminating interference waves, bandpass filter 15, phase shifter (PHST) 22 for phase shifting a local signal by 90°, modulator 21 for modulating the transmitted signal with the local signal and frequency converting it into a high-frequency signal, and power amplifier 14 for amplifying the transmitted signal at a fixed level.

In the present embodiment, control signal sg for gain switching from controller 12 is supplied to PGA 10 and 11, and while the gain is switched by the control signal in PGA 10 and 11, control is also performed to suppress the voltage level of transient response due to filter characteristics within PGA 10 the 11.

Flow of a received signal will be described now. A received signal by antenna 1 is subjected to single-differential conversion in DPX 2. The signal from DPX 2 is subjected to low noise amplification in LNA 3 and 4 and fed into mixers 5 and 6. Meanwhile, a local signal is output from VCO 9 and the output signal is subjected to divide-by-two operation in frequency divider 8, and then the signal is brought to a fixed output level in buffer 7 to be output to mixers 5 and 6. The received signal and the local signal are multiplied together In mixers 5 and 6 for frequency conversion and the frequency-converted, desired signal is fed into PGA 10 and 11, where the signal is subjected, responsive to control signal sg output from controller 12, to gain control and elimination of interference waves received from the antenna. Thereafter, the signal is input to base-band block 13.

Flow of a transmitted signal will now be described. A transmitted signal from base-band block 13 is amplified in variable amplifiers 25 and 26 and interference waves therein are eliminated in low-pass filters 23 and 24. The transmitted signal with interference waves eliminated therefrom is fed into modulator 21 and subjected therein to modulation with the local signal from phase shifter 22 to be frequency converted into a high-frequency signal. The frequency-converted transmitted signal is amplified in variable amplifiers 18, 19, and 20, and then interference waves are eliminated therefrom in low-pass filter 17. The signal is further amplified in variable amplifier 16 and passed through band-pass filter 15 for elimination of interference waves therefrom. The signal is then amplified to a fixed level in power amplifier 14 and transmitted from antenna 1 through DPX2.

Below will be described operation of PGA 10 and 11 in detail. Since PGA 10 outputting I output signal and I bar (IB) output signal and PGA 11 outputting Q output signal and Q bar (QB) output signal are of the same structure, description will be made here about PGA 10. As shown in FIG. 1, PGA 10 is made up of amplifiers 27, 31, 33, and 36 for providing a constant-gain output, low-pass filters (LPF) 28, 29, and 34 for passing a signal at a frequency lower than a specified value, and HPFATT circuits 30, 32, and 35 having both a high-pass filter function for passing a signal at a frequency higher than a specified value and an attenuator function for decreasing an amplitude of a signal.

In the present embodiment, amplifiers 27, 31, 33, and 36, LPF 28, 29, and 34, and HPFATT circuits 30, 32, and 35 each have a different characteristic from one another.

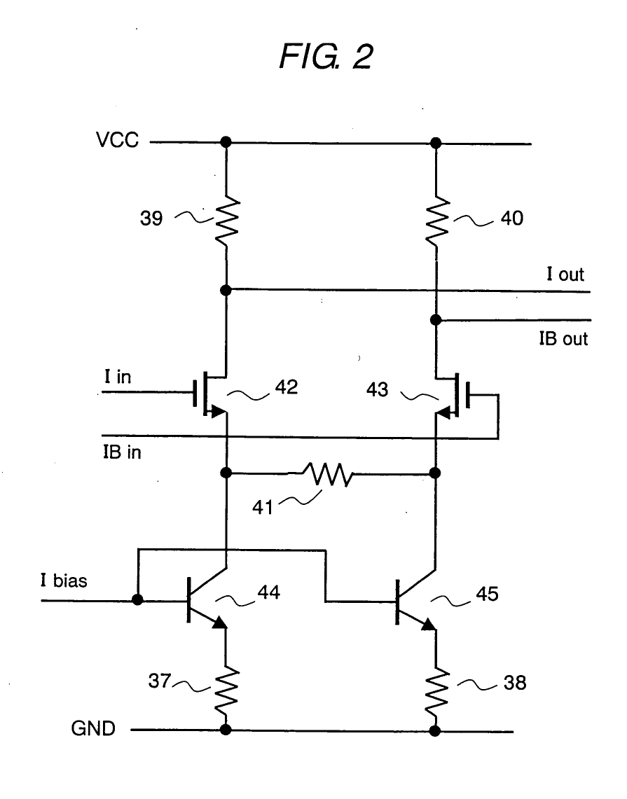

A configuration example of an amplifier within PGA 10 is shown in FIG. 2. The amplifier Is constituted of resistors 37 to 41, NPN transistors 44 and 45, and NMOS transistors 42 and 43. NMOS transistors 42 and 43 and resistors 39 and 40 constitute a differential amplifier and resistor 41 is inserted to improve linearity of the amplifier.

NPN transistors 44 and 45, supplied with bias current I bias, together with resistors 37 and 38 constitute a constant-current power source. Each amplifier is a fixed-gain amplifier for outputting input signal I, IB after providing the same with a fixed gain. A frequency-converted signal in mixers 5 and 6, upon being fed into PGA 10, is amplified by amplifier 27 to a fixed level and input to LPF 28.

Although there is shown in FIG. 2 a circuit configuration using MOS transistors as amplifiers in PGA, it is preferred, for improving the noise characteristic, to use a bipolar transistor configuration employing NPN transistors having a better noise characteristic for amplifier 27 in the first stage, Instead of NMOS transistors 42 and 43.

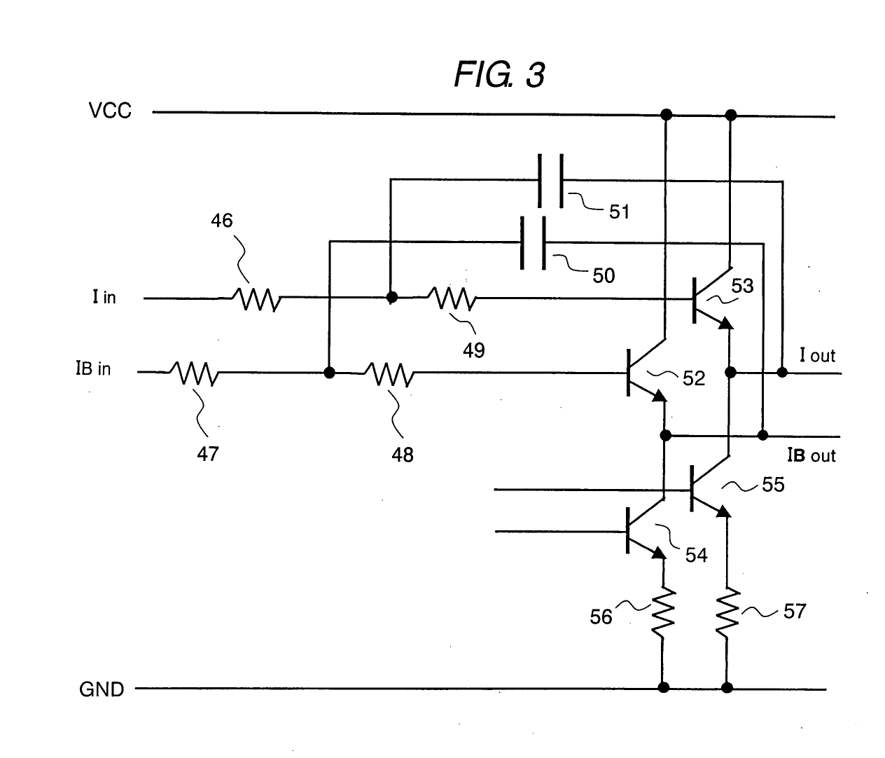

A configuration example of LPF 28 is shown in FIG. 3. LPF 28 is constituted of resistors 46 to 49, 56, and 57, capacitors 50, 51, and NPN transistors 52 to 55. While an emitter follower is formed of resistor 56 and 57 and NPN transistors 52 to 55, a second-order low-pass filter of the Sallen-Key type is constituted of the emitter follower, resistors 46 to 49, and capacitors 50 and 51. Base of transistors 54 and 55, supplied with a bias current, and resistors 56 and 57 constitute a constant current power source. Unwanted signal on the high frequency side are eliminated in LPF 28 and wanted signal on the low frequency side only are passed therethrough. Then, also In LPF 29, interference waves on the high frequency side are eliminated from output signals Iₒᵤₜ and IBₒᵤₜ, and desired waves on the low frequency side only are allowed to pass. Output signals from LPF 29 are input to HPFATT circuit 30 having both a high-pass filter function and an attenuator function.

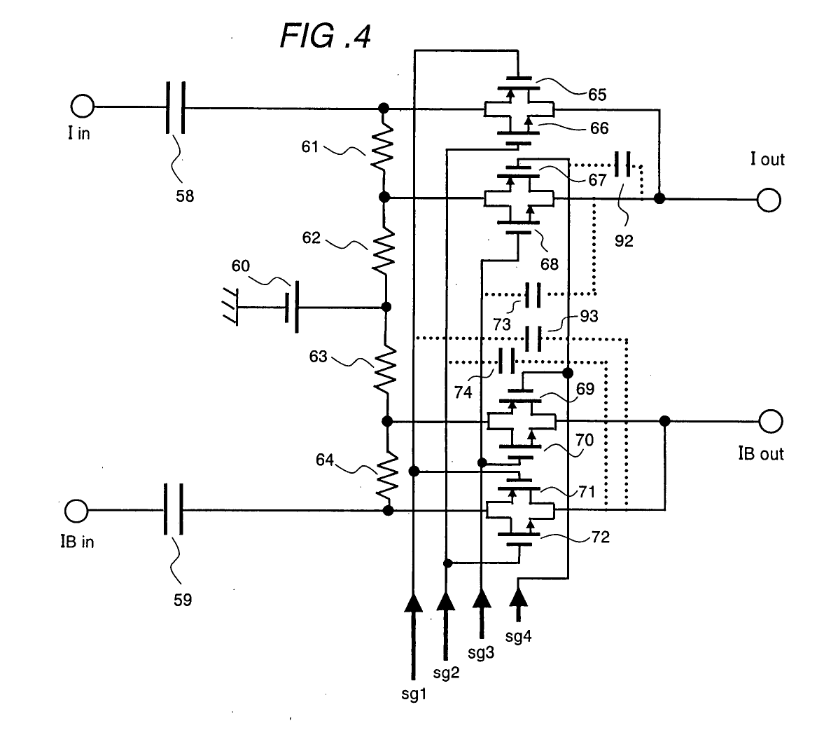

A configuration of HPFATT circuit 30 is shown in FIG. 4. The HPFATT circuit is made up of capacitors 58 and 59, bias source 60, resistors 61 to 64, and a plurality of MOS switches, each of which is formed of each pair of PMOS transistor and NMOS transistor of a plurality of NMOS transistors (hereinafter briefly called “NMOS”) 66, 68, 70, and 72 and PMOS transistors (hereinafter briefly called “PMOS”) 65, 67, 69, and 71. A high-pass filter function is structured of capacitors 58 and 59 connected in series with each signal line of I, IB, and resistors 61 to 64 connected in parallel with the signal lines. Further, since the signal level is attenuated by the resistor inserted in the signal line of I, IB by switching of MOS switches, gain switching function of amplifier 31 is also provided by the attenuating function. Thus, by providing both gain switching function and high-pass-filter function by means of input capacitors and resistors, an effect to reduce the circuit area can be obtained.

ON/OFF control of MOS switches is performed by control signals sg1 to sg4 from controller 12. Attenuation levels of signals on the side of I and IB are respectively determined by the ratios between resistor 61 and resistor 62 and between resistor 63 and resistor 64.

Here, an example of signal switching will be described taking, as examples, a case where I input signal Iᵢₙ is switched from a path passing through a MOS switch formed of PMOS 65 and NMOS 66 to a path passing through resistor 61 and a MOS switch formed of PMOS 67 and NMOS 68, and a case where IB input signal IBᵢₙ is switched from a path passing through a MOS switch formed of PMOS 72 and NMOS 71 to a path passing through resistor 64 and a MOS switch formed of PMOS 69 and NMOS 70. A bias is assumed to be given by bias power source 60. In IC circuits, parasitic components are produced in devices and, further an offset is produced between parasitic components on the side of I and the side of IB.

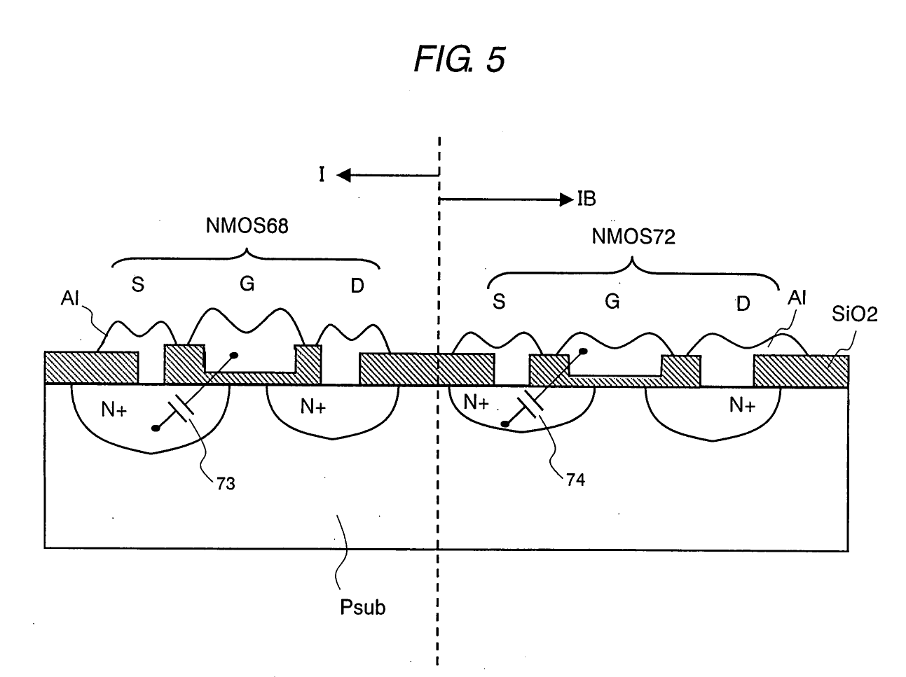

In FIG. 5, there is shown an example of parasitic components produced in devices and an offset therebetween. In FIG. 5, there are shown NMOS 68 and 72, each of which is produced, first, by forming N⁺ diffused layers of drain D and source B in P-type substrate P_{sub} and, then, forming gate electrode G over the channel region between the drain and base diffused layers with a thin gate insulating film disposed in between. Parasitic capacitances 73 and 74 are produced between the source diffusion layer and gate electrode G insulated by gate insulating film of each of NMOS 68 on the I side and NMOS 72 on the IB side. However, there is also produced an offset between the parasitic capacitance on I side and IB side depending on difference in pattern such as the run length of gate wiring and the area and length of the intersecting portion of the gate with the diffusion layer. Although only NMOS is shown in FIG. 5, also with PMOS 67 and PMOS 71 formed in N well not shown, there are produced parasitic capacitances 92 and 93 between the gate and source as shown in FIG. 4.

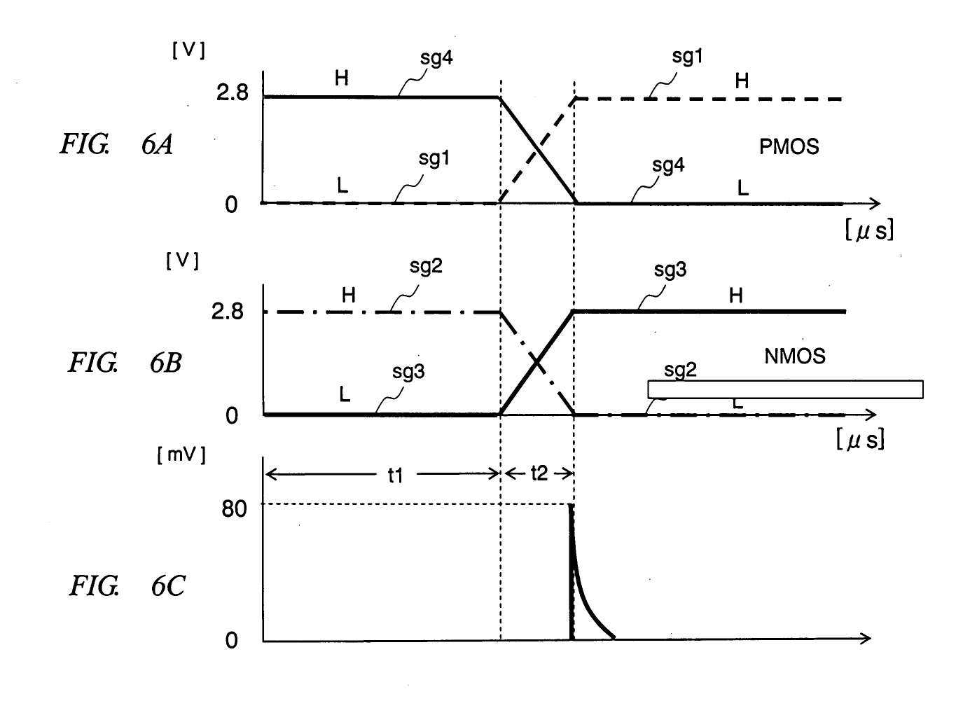

Progression over time of values of control signals sg1-sg4 is shown in FIGS. 6A and 6B. During the period of t1 from 0 μs to 300 μs shown in FIG. 6, let it be assumed that control signal sg1 and sg2 are low (“L”) and high (“H”), respectively. Then, PMOS 65 and 71 and NMOS 66 and 72 disposed on the outer side of the signal lines are all in ON state. On the other hand, when it is assumed that control signal sg3 and sg4 during the same period of time are “L” and “H”, respectively, PMOS 67 and 69 and NMOS 68 and 70 disposed on the inner side of the signal lines are all in OFF state.

By reversing polarities of the control signals during period t2 from 300 μs to 400 μs, for switching the signal paths from the outer side to the inner side, thereby setting control signals sg1, sg2, sg3, sg4 to “H”, “L”, “H”, “L” at the point of time of 400 μs, PMOS 67 and 69 and NMOS 68 and 70 disposed on the inner side of the signal paths are all turned ON, while PMOS 65 and 71 and NMOS 66 and 72 disposed on the outer side of the signal paths are all turned OFF.

When control as shown in FIGS. 6A and 6B is performed, potential of I output and IB output in the HPFATT circuit varies due to charging of the parasitic capacitance during period t2. Because of difference of the parasitic capacitance values between I side and IB side, the values of potential variation differ between I side and IB side. This potential difference exists while the parasitic capacitance of MOS switches is charged and it is amplified by amplifier 31 placed in the stage subsequent to HPFATT 30. The potential difference is amplified by amplifier 31 during this period of charging, and a high-level rise signal is generated. When this rise signal is Input to HPFATT 32, a transient response having a peak value as high as 80 mV is generated due to the high-pass-filter characteristic at the node subsequent to the input capacitor of HPFATT 32 as shown in FIG. 6C.

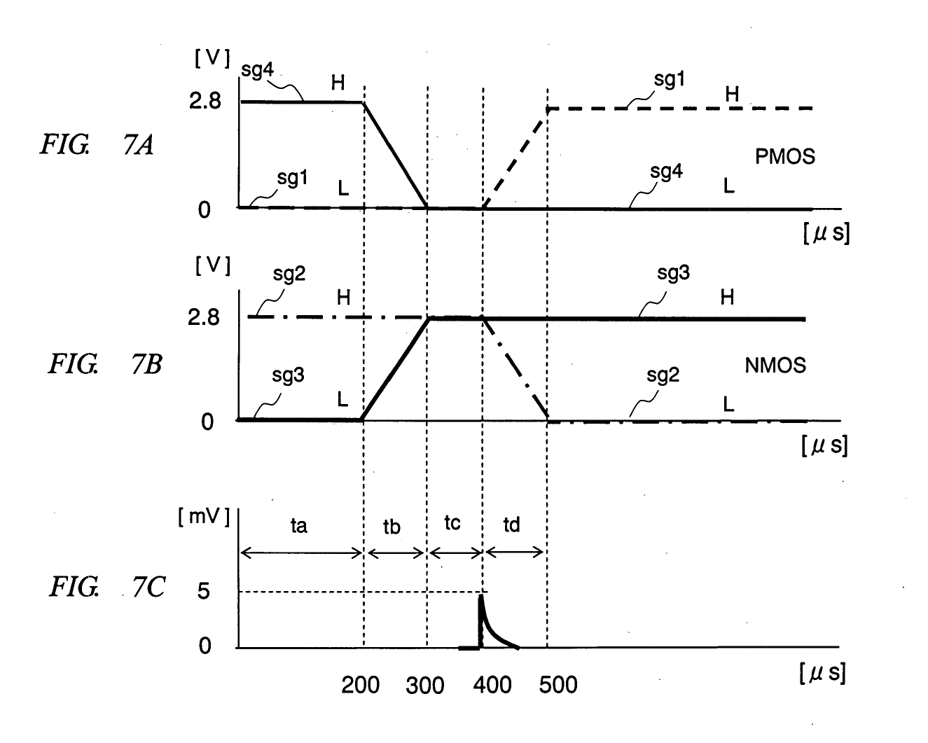

Then, such a case will be described where input taming of control signals sg1 to sg4 is controlled such that there is a period during which MOS switches of the signal lines on the outer side and the MOS switches of the signal lines on the inner side are simultaneously turned ON as shown in FIGS. 7A and 7 B. During period ta from 0 μs to 200 μs, let it be assumed that control signals sg1 and sg2 are set to L and H, respectively. Then, PMOS 65 and 71 and NMOS 66 and 72 disposed in the signal paths on the outer side are all turned ON.

In contrast to the above, during the same period ta, if it is assumed that control signals sg3 and sg4 are set to “L” and “H”, then PMOS 67 and 69 and NMOS 68 and 70 disposed on the signal lines on the inner side are all turned OFF. Here, by reversing the polarities of control signals sg3 and sg4 during period tb between 200 μs and 300 μs, thereby causing control signals sg3 and sg4 to go “H” and “L”, respectively. PMOS 67 and 69 and NMOS 68 and 70 disposed in the signal lines on the inner side are all turned ON.

Since all PMOS 65 and 71 and NMOS 66 and 72 disposed In the signal paths on the outer side are already in ON state, MOS switches in the signal paths before and after switching during period to between 300 μs and 400 μs are all in ON state. By reversing the polarities of control signals sg1 and sg2 during period td between 400 μs and 500 μs, for switching the signal paths from the outer side to the inner side, thereby causing control signals sg1 and sg2 to respectively go “H” and “L” at the point of time of 500 μs, PMOS 65 and 71 and NMOS 66 and 72 disposed in the signal paths on the outer side are all turned OFF.

When control as shown in FIGS. 7A and 7B is performed, there is a period during which control signals are overlapping with each other and, hence, output DC voltage on I side and IB side of the HPFATT circuit becomes constant at all times. Hence, 6 potential variation occurring when the parasitic capacitance is charged becomes small, i.e., the peak value of transient response becomes as low as 5 mV as shown in FIG. 7C and, thus, the transient response can be suppressed sufficiently in contrast with 80 mV in the case of control shown in FIGS. 6A and 6B.

Thus, in the present embodiment, by controlling the control signals such that the times when MOS switches of the signal paths are turned ON overlap before being switched, it becomes possible to suppress the transient response as shown in FIG. 7C. Although switching of two signal paths has been described in the present embodiment, the number of signal paths may be greater than two. Since a high-pass-filter configuration can be made by arranging capacitors 58 and 59 in series with the signal paths and resistors 62 to 64 in parallel with the signal paths, the area of circuit can be reduced. Further, by using MOS transistor amplifiers in the stages subsequent to HPFATT 30, 32, and 35, reduction of current consumption can be achieved because of there being no flows base current as in bipolar transistors.

With regard to the direct conversion transmitter/receiver of the configuration shown in FIG. 1, this embodiment is preferably applicable to suppression of transient response occurring when gain is switched, which is a problem involved in a reception method without intermittent time such as CDMA (Code Division Multiple Access) receiving system. In that case, an RF received signal of CDMA system is amplified in a low noise amplifier and fed into a reception mixer and a down converted signal is input to PGA.

Incidentally, in the configuration shown in FIG. 1 of the direct conversion transmitter/receiver described in the present embodiment, other circuits than base band block 13, bandpass filter 15, low-pass filter 17, power amplifier 14, antenna 1, and DPX 2 are arranged on semiconductor integrated circuit chips.

A second embodiment of wireless communication receiver of the present invention will be described below. The configuration of the present embodiment will be described with the same direct conversion receiver as shown in FIG. 1 taken as an example. Since the configuration of the receiver and the flow of received signal are the same as described in the first embodiment, description of the same will be omitted to avoid overlaps. The description of the present embodiment will be begun with the processing performed after a received signal has been input to PGA 10.

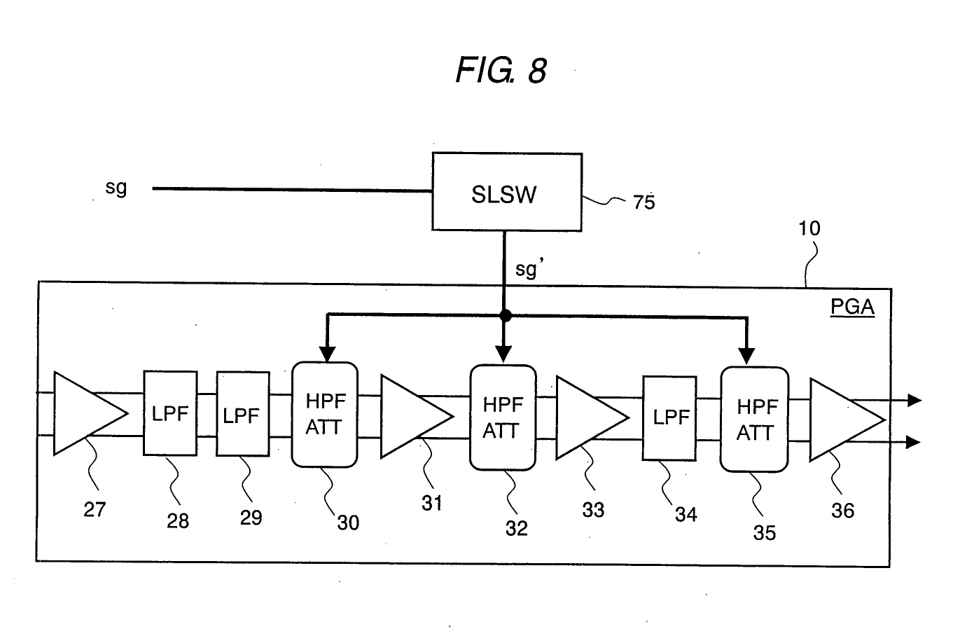

The structure of PGA 10 is shown in FIG. S. The configuration of the present embodiment is different from that of the first embodiment in that control signal sg from controller 12 of FIG. 1 is supplied to HPFATT circuits 30, 32, and 35 within PGA 10 through slow switch 75. Although slow switch (SLSW) 75 is shown as provided outside the PGA 10 in FIG. 8, it may be provided within PGA 10.

In the present embodiment, control signal sg output from controller 12 is temporarily input to slow switch 75 and it is then supplied to each of HPFATT 30, 32, and 35 within PGA 10 after the rising edge and falling edge of the control signal have been delayed by some period of time.

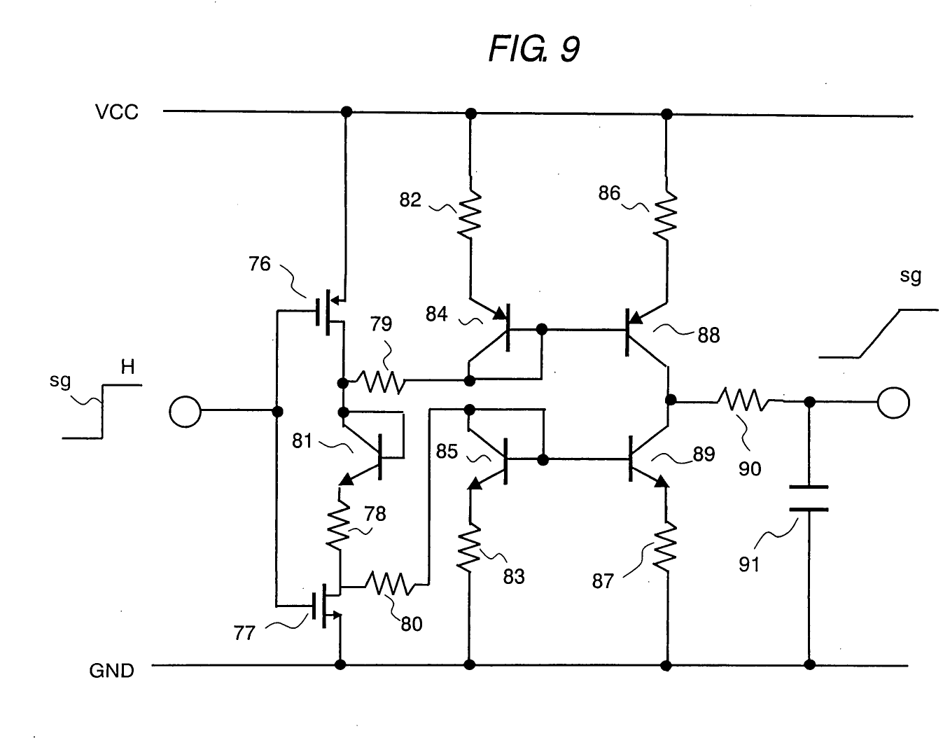

An example of circuit configuration of slow switch 75 is shown in FIG. 9. Slow switch 75 is constituted of PMOS 76, NMOS 77, resistors 78 to 80, 82, 83, 86, 87, and 90, NPN transistors 81, 85, and 89, PNP transistors 84 and 88, and capacitor 91.

Operation of slow switch 75 will now be described. When input control signal sg is “H”, NMOS 77 Is turned ON and PMOS 76 and NPN transistors 85 and 89 are turned OFF. Turning ON of NMOS 77 causes a current to flow through resistor 82, diode-connected PNP transistor 84, diode-connected NPN transistor 81, and resistor 78. Thereby, PNP transistor 88, constituting a current mirror with PNP transistor 84, Is turned ON to cause a current to flow through resistor 86 and PNP transistor 88, so that capacitor 91 of a low-pass filter, constituted of resistor 90 and capacitor 91 on the output side, is charged. The time for the control signal to go “H” is delayed by the period of time taken for charging capacitor 91.

On the other hand, when input control signal is “L”, NMOS 77 is turned OFF and PMOS 76 is turned ON. This causes a current to flow through PMOS 76, diode-connected NPN transistor 81, resistors 78 and 80, diode-connected NPN transistor 85, and resistor 83. Thereby, NPN transistor 89, constituting a current mirror with NPN transistor 85, having their bases connected in common, is turned ON, so that capacitor 91 of the low-pass filter, constituted of resistor 90 and capacitor 91 on the output side, is discharged. The time for the control signal to go “L” is delayed by the period of time taken for the discharging.

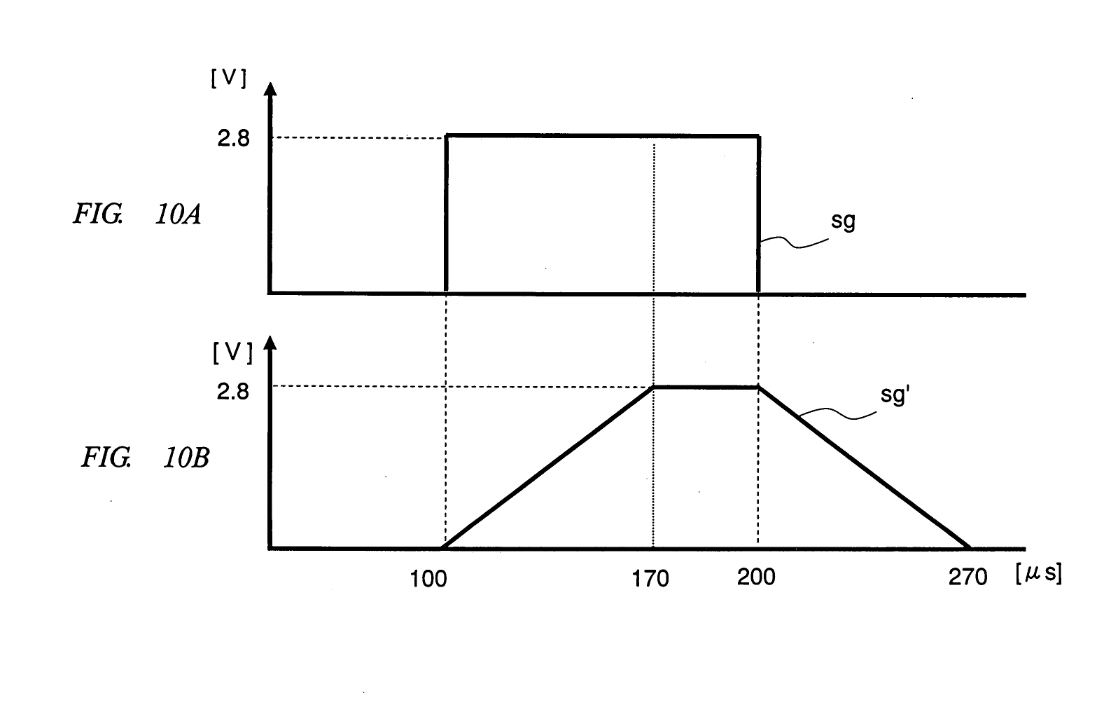

Control signal sg is shown in FIG. 10A and control signal sg′ delayed 70 μs therefrom is shown in FIG. 10B. This delayed control signal sg′ is input to each of internal MOS switches of HPFATT 30, 32, and 35, whereby the MOS switches are switched over and a gain adjustment of the received signal is achieved. In this case, with respect to the switching timing of the control signals, overlapping of the switching times of the control signals is not needed, in contrast to the case of the first embodiment. By the described arrangement, transient response can be suppressed as shown In FIG. 7C.

Now, a third embodiment of a wireless communication receiver of the present invention will be described. The configuration of the present embodiment will be described with the same direct conversion receiver as the first embodiment taken as an example. Since the configuration of the receiver and the flow of signal are the same as in embodiment 1, description of the same will be omitted to avoid overlaps. In the present embodiment, timing of the rising edge and falling edge of the control signal are delayed by means of slow switch 75 described in the second embodiment and, in addition, control is performed such that control signals overlap as shown in FIGS. 7A and 7B. Thereby, it becomes possible to suppress transient response as shown in FIG. 7C. The present embodiment has an advantage over the case of the first embodiment or second embodiment that better suppression of transient response can be achieved.

Although there have been described preferred embodiments of the present invention, the present invention is not limited to such embodiments. Manifestly it is possible to make various modifications and rearrangements without departing from the spirit and scope of the present invention.

What is claimed is:

1. A wireless communication receiver comprising:
a programmable gain amplifier; and
a gain controller for controlling a gain in the programmable gain amplifier,
the programmable gain amplifier including an attenuator made up of a plurality of voltage dividing resistors serially connected between signal input nodes and a reference potential point and a plurality of switches connected between a plurality of nodes of the voltage dividing resistors and signal output nodes, wherein
the attenuator is set to provide a specified attenuation by the gain controller bringing selected switches of the plurality of switches in the programmable gain amplifier into conduction and the gain of the programmable gain amplifier is established by the specified attenuation.

2. The wireless communication receiver according to claim 1, wherein
each of the plurality of switches constituting the attenuator is a CMOS analogue switch formed of a PMOS transistor and an NMOS transistor, and, while one of selected two switches of the plurality of switches is changed from ON to OFF and the other is changed from OFF to ON, there is provided a period that both of the selected switches are ON.

3. The wireless communication receiver according to claim 1, wherein
the output nodes of the programmable gain amplifier are connected with a differentiating circuit, the signal input nodes of the programmable gain amplifier are connected with outputs of received-signal mixers, and inputs of the received-signal mixers are connected with outputs of low noise amplifiers for amplifying a received CDMA RF signal, and a received CDMA base-band signal is obtained from an output of the differentiating circuit.

4. The wireless communication receiver according to claim 1, wherein
the gain controller and the programmable gain amplifier are formed on a semiconductor integrated circuit chip.

5. The wireless communication receiver according to claim 3, wherein
the received-signal mixer is a mixer for direct down conversion.

6. The wireless communication receiver according to claim 1, wherein
the gain controller controls rising timing and falling timing of a control signal.

7. The wireless communication receiver according to claim 6, wherein
control of rising timing and falling timing performed by the gain controller is control performed with use of a charging and discharging characteristic of an integrating circuit.
